(19) United States
(12) Patent Application Publication
(10) Pub. No.: US 2009/0051133 A1
(43) Pub. Date: Feb. 26, 2009

(54) Dolly Apparatus For Bag Toss Game

(76) Inventor: Danny Oshiro, Naperville, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 12/197,219

(22) Filed: Aug. 22, 2008

Related U.S. Application Data
(60) Provisional application No. 60/965,742, filed on Aug. 22, 2007.

(51) Int. Cl. B62B 1/26

(52) U.S. Cl. 280/47.18; 273/348

(57) ABSTRACT

A dolly specially suited for use with the game apparatus of the games referred to as “Bags”, “Beanbag Toss” or “Corn Hole.” The dolly includes a support frame, a lifting frame, wheels, and a handle for transporting goals. Drink holders, a storage container and a score indicator can be deployed on the support frame.

This application claims the benefit of U.S. Provisional Application No. 60/965,742, filed Aug. 22, 2007.

### BACKGROUND OF THE INVENTION

A game, commonly known as “Bags”, “Beanbag Toss”, or “Corn Hole” is played by two or more participants and comprises the use of several weighted bags known as beanbags, and two wedge-shaped goals. Each goal has a hole on its angled top surface, and the object of the game is to toss a beanbag into the hole. This is a very popular game at social gatherings, especially outdoors during nice weather. The game has recently become popular on college campuses. There are now Corn Hole tournaments that include many games in a large field being played simultaneously.

To play the game, the two goals are spaced apart on a lawn and the participants stand adjacent to a near goal and toss a beanbag toward the distant goal, attempting to toss the beanbag into the hole of the distant goal. The goals are spaced significantly apart in order to present a challenge to the participants in tossing beanbags in the respective holes.

To set up the game, the wedge-shaped goals need to be carried to their desired locations from their places of storage. The goals are large and often heavy due to being constructed of wood or another durable material. Since the game of Corn Hole is usually played outside in a yard, hand carrying the goals from inside the house or other place of storage to place the goals spaced apart on the lawn can be a cumbersome task, particularly during a tournament situation where many goals must be placed at a far distance from the storage location.

Also, during storage, transportation, and cleanup after the games, beanbags are often lost and the beanbags must all be checked, recounted, and found before the game can begin.

Also, Corn Hole is a social game, often played at parties and social gatherings, in which the participants may be holding some sort of drink and/or snack food. Given that this game is often played outdoors, it is difficult for the participants to find a safe place to place their drink and/or snack while playing the game on the lawn. Drinks and snack foods placed on the grass can be knocked over or trampled by the players or others.

Furthermore, during casual backyard games, the participants keep track of the score by memory, out of which often rise discrepancies and disagreements. In official tournaments, scoreboards are used, but they are often flimsy, hard to read, and prone to being blown about by the wind.

The present inventor has recognized the need for an apparatus to aid in the transportation of the goals required for the game of Corn Hole.

The present inventor has recognized the need for an apparatus to effectively contain and hold the beanbags during storage and transportation.

The present inventor has recognized the need for an apparatus that provides a support and securing apparatus for food and/or drink for the participants of the game of Corn Hole.

The present inventor has recognized the need for an apparatus that provides an effective, sturdy, and accurate scoring means to keep track of each team's score in a game of Corn Hole.

### SUMMARY OF THE INVENTION

The present invention provides a dolly apparatus for use with the game apparatus of “Bags”, “Bean Bag Toss” or “Corn Hole.” The dolly includes a support frame, a lifting frame, wheels, and a gripping handle for transporting goals.

Drink holders, a storage container and a score indicator can be deployed on the support frame.

According to one embodiment drink holders are resiliently clamped to the support frame and can be slid vertically and rotated on the support frame for desired positioning, outward for a deployed position and offset and inward for storage.

According to one embodiment, a convenience console is deployable from the support frame. The console can be hingedly mounted on the support frame, or can be detachable and movable between alternating positions including a deployed position and a stored, retracted position. The console preferably has cup holders, clips on the sides for retaining snack bags, other compartments as needed, and can have a flat-surface table-like area for various other uses.

The storage container can be a bag attached to the support frame or console for holding beanbags. The bag can be of mesh or other material, and can be re-openable and re-closeable by means of a variety of sealing means, for example, by a zipper.

The score indicator can be a scoring meter with movable team indicators. The meter can be a thin board made of plastic, wood, or other material with notches or lines representing points to be aligned with team-specific tabs, clamps or pegs. The meter can be removably mounted to the support frame or retract into and out of the support frame, or fold down against the frame for storage. The scoreboard can be rigid and rigidly held by the frame to ensure stability while the scoreboard is extended and on display.

In another embodiment, rather than being built-in to be a part of the dolly, a console including the cup-holders and other compartments, with the beanbag carrying bag, and scoring means can all be slipped over the upper frame of a conventional dolly.

In another embodiment, the Beanbag goal transporting means is achieved through a transporting apparatus that is built into the goals. A retractable handle can be built into a first end of the wedge-shaped goal, and retractable wheels can be built in to the opposite end of the bottom face of the wedge. During play, the handle can slide into the underside of the goal, so as not to interfere with operation of the game. During transportation, the handle can be extended to provide a gripping surface for pulling the goal. The wheels can be pivotally mounted, so that during play, they can be retracted above the bottom face of the wedge, so the wedge can lay flat on the ground. During transportation, the wheels will be pivoted down to a latched, deployed position to make the goal easily wheeled by a person gripping the extended handle.

According to another embodiment, rather than a two wheeled dolly, a four-wheeled cart can be utilized to transport the goals wherein the cart includes the accoutrements described above with respect to the dollies.

The invention also provides a useful dolly for possible other applications wherein the dolly includes a drink holder and/or utility shelf and/or a storage container.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a perspective view of a dolly apparatus of the present invention;

FIG. 1A is an enlarged, fragmentary side view of the apparatus shown in FIG. 1;

FIG. 1B is a side view of the apparatus shown in FIG. 1 shown in a folded up condition;

FIG. 1C is a side view of the apparatus shown in FIG. 1 shown in use to pull a goal;

FIG. 2 is a perspective view of a second embodiment of the invention;

FIG. 3 is a side view of a third embodiment of a dolly apparatus having transportation elements deployed;

FIG. 4 is a side view of the dolly apparatus of FIG. 3 having transportation elements retracted;

FIG. 5 is a bottom view of the dolly apparatus of FIG. 3 having transportation elements deployed;

FIG. 6 is a perspective view of a fourth embodiment dolly apparatus of the invention;

FIG. 7 is a rear perspective view of a fifth embodiment dolly apparatus of the invention with drink holders shown in a deployed position; and

FIG. 8 is a front perspective view of the fifth embodiment shown in FIG. 7 with drink holders shown in a storage position;

FIG. 8A is a top view of a bracket taken along line 8A-8A of FIG. 8; and

FIG. 9 is a schematical elevational view of a score indicator according to the invention.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

This application claims the benefit of U.S. Provisional Application No. 60/965,742, filed Aug. 22, 2007, the entire specification of which is herein incorporated by reference.

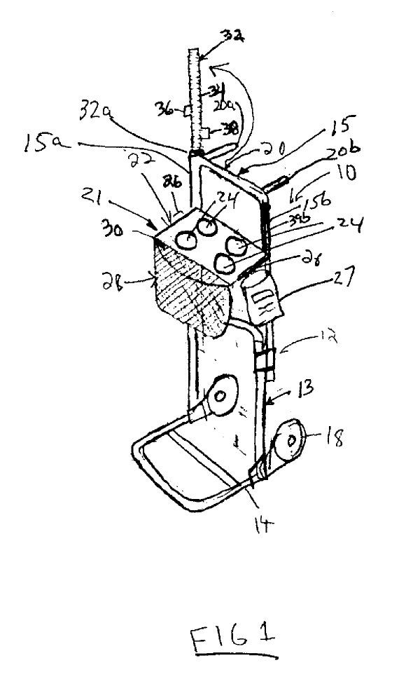

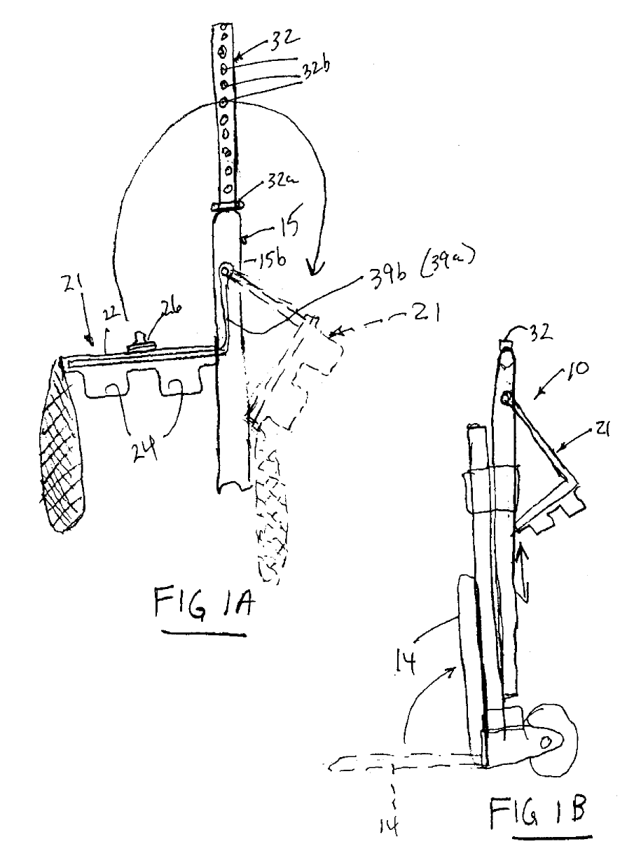

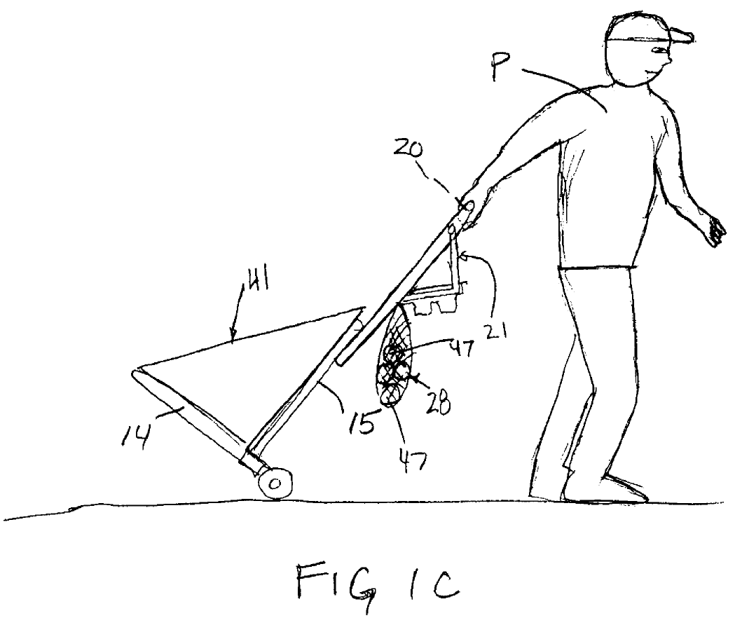

FIG. 1 illustrates a dolly apparatus 10 having a support frame 12 attached to a lifting frame or lifting plate 14. The lifting frame 14 supports the weight of the object to be lifted and transported. Wheels 18 are mounted to the lifting frame 14. The support frame 12, lifting frame 14 and wheels 18 can all be arranged and configured according to the heretofore known configurations for dollies. Particularly advantageous is a configuration of a folding dolly or luggage carrier such as disclosed in U.S. Pat. Nos. 4,969,660; 4,754,985; and 6,012,729, all herein incorporated by reference.

The support frame 12 includes a first inverted U-shaped frame portion 13 and a second inverted U-shaped frame portion 15 slidably attached to the first portion 13. The second U-shaped frame portion 15 includes a handle bar 20 that provides an easy gripping surface for an operator to control the movement of the apparatus and pull the apparatus (see FIG. 1C). As an option, grip handles 20a, 20b can be provided extending rearward which allow easy pushing of the dolly apparatus. If the goal 41 has a height when stood up on the support plate 14 greater than the height of the handle bar 20, the rearward position of the grip handles 20a, 20b prevents pinching of the user's hands otherwise caught between the carried target 41 and the handle bar 20.

A console 21 is mounted to the second portion 15. The console 21 is preferably a molded plastic piece that includes a shelf 22 that extends from second portion 15 and includes formed cup-holding recesses or cup-holders 24. Snack-holding clips 26 for holding snack bags 27 are fastened to the shelf 22. A beanbag holding bag 28 can be fastened to a front edge of the shelf 22 of any other appropriate position on the dolly. Beanbag holding bag 28 includes a closing means, for example a zipper 30.

A scoring meter 32 extends upward from the frame 12. Scoring meter 32 includes numbered notches or lines 34 indicating score, and tabs, clips, or pegs 36, 38 representing Team 1 and Team 2, respectively. Tabs, clips, or pegs 36, 38 are manually movable along scoring meter 32 to keep track of the score of the game. The meter can telescope into a vertical leg 15a of the second frame portion 15 or can have a hinge 32a that allows the meter to fold down against the handle 20 for storage or transportation. Alternately, other ways of deploying the meter 32 are possible such as by a removable connection, wherein the meter can be removed and put into the bag 28 for storage.

FIG. 1A illustrates a portion of the dolly apparatus of FIG. 1. The console 21 is supported by identical and parallel L-shaped rods 39a, 39b hung from pivot connections to outsides of the second frame portion legs 15a, 15b, respectively. The pivot connections allow the console to be swung around a top of the second frame portion 15 to the storage location indicated in dashed lines in FIG. 1A. In the deployed position, since the L-shaped rods 39a, 39b are located outside the legs 15a, 15b, the shelf and/or rods hold the shelf 22 perpendicular to the second frame portion 15 by pressing against the second frame portion legs 15a, 15b.

Holes 32b for score pegs or indicators for one team are shown in FIG. 1A.

FIG. 1B illustrates the dolly 10 in a folded condition with the console 21 folded to a back side of the dolly and the meter 32 folded against the handle 20.

FIG. 1C illustrates a person P pulling a goal 41 on the dolly 10. A plurality of beanbags 47 are held within the storage bag 28. The console 21 is folded over to the back side of the dolly to ensure non-interference with the goal 41 being carried on the lifting frame 14 and the support frame 12.

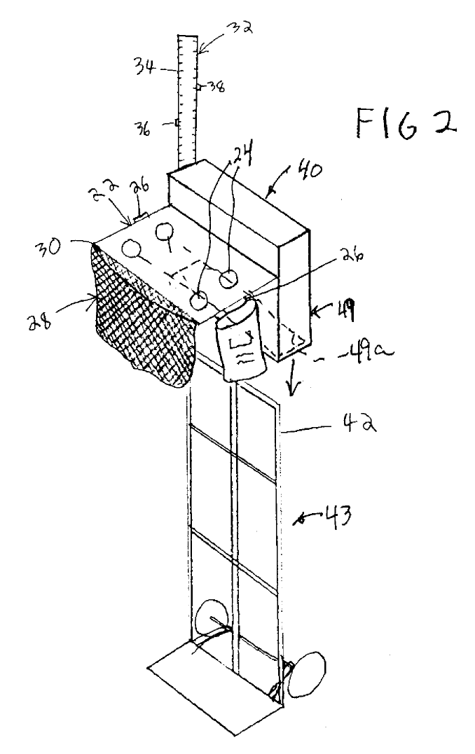

FIG. 2 shows a second embodiment comprising a separate dolly 43 and a sleeve console 40. Sleeve console 40 includes a base 49 that is designed to slip over the support frame 42 of the conventional dolly 43. The base comprises a box with an open bottom face 49a that receives a top portion of the support frame 42. The base 49 is attached to the heretofore described shelf 22 with the cup-holding recesses 24, snack-holding clips 26, and beanbag holding bag 28. The scoring meter can also be attached to the base in a retractable manner as heretofore described to prevent damage during transportation. The sleeve console can advantageously be molded as a single plastic piece.

FIGS. 3-5 show a third embodiment of the present invention. Wedge shaped goal the 54 includes a retractable handle 56, which is manually slidable between retracted and deployed positions. FIGS. 3, 4, and 5 show the retractable handle 56 in deployed, retracted, and partially-deployed positions, respectively. The handle 56 includes a gripping bar 57 attached to two legs 58, 59. The legs are slidably captured in channels 60, 61 which afford a limited extension and stop when the deployed position is reached. Alternately, the handle could be permanently fixed in the deployed position.

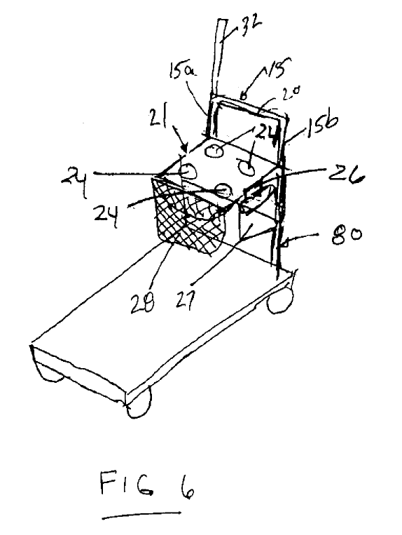

A goal hole 44a is also shown in FIG. 5.

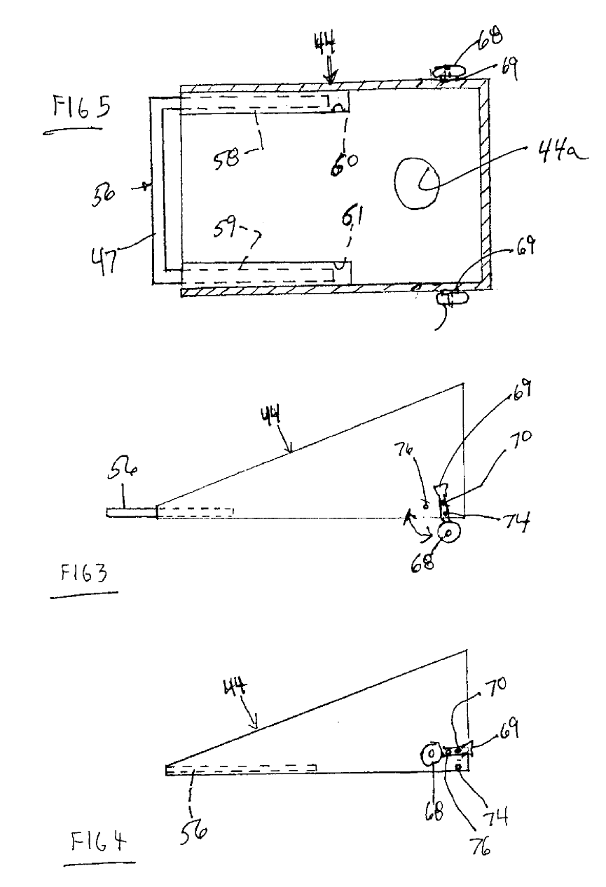

On the opposite end of wedge shaped goal 44 are wheels 68 mounted rotatably on brackets 69 which pivot about axes 70 between fixed deployed positions (shown in FIG. 3) and fixed retracted (shown in FIG. 4) positions, that are set by detents 74, 76. An example of this type of wheel elevation adjustment and fixation can be found on the wheel height adjustments on a common lawnmower and is described in U.S. Pat. No. 5,493,851, herein incorporated by reference. Alternately the wheels could be permanently fixed in the deployed position.

FIG. 6 illustrates another embodiment of the invention wherein the console 21 is mounted onto a four wheel luggage cart 80. The console 21 can have the same features and be mounted in the same manner as set forth in FIG. 1-1A or can be a separate sleeve console 40 as set forth in FIG. 2.

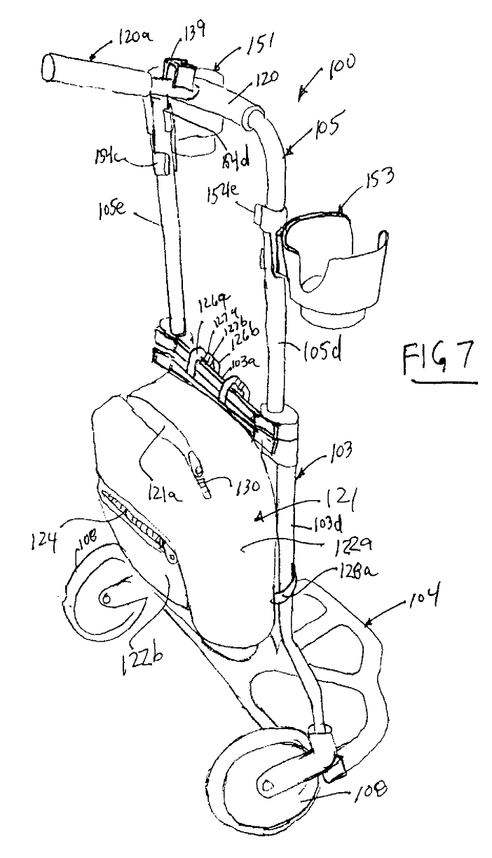

FIGS. 7 through 9 illustrate another embodiment dolly apparatus 100 having a support frame 102 attached to a lifting frame or lifting plate 104. The lifting frame 104 supports the weight of the object to be lifted and towed. Wheels 108 are mounted to one or both of the lifting frame 104 and the support frame 102. The support frame 102, lifting frame 104 and wheels 108 can all be arranged and configured according to the heretofore known configurations for dollies; particularly advantageous is a configuration of a folding dolly or luggage carrier such as disclosed in U.S. Pat. Nos. 4,969,660; 4,754,985; and 6,012,729, all herein incorporated by reference.

The support frame 102 includes a first inverted U-shaped frame portion 103 and a second inverted U-shaped frame portion 105 slidably attached to the first portion 103. The second U-shaped frame portion 105 includes a handle bar 120 that provides an easy gripping surface for an operator to control the movement of the apparatus and pull the apparatus. As an option, a grip handle 120a can be provided extending rearward, and inclined slightly upward which allow easy pushing of the dolly apparatus. If the goal 41 has a height when stood on the plate 104 greater than the height of the handle bar 120, the rearward position of the grip handle 120a prevents pinching of the user's hand otherwise caught between the carried target 41 and the handle bar 120. The members 120, 120a can be padded for user comfort.

The second frame portion 105 can be lowered with respect to the first frame portion 103 once a clasp 116 is manually released, to collapse the dolly for storage. The crossbar 103a, the connectors 103b, 103c and the vertical members 103d, 103e are all stationary with respect to the plate 104. The latch 116, when released from the member 103a, can be lowered on a telescopically collapsible tube 116a as a crossbar 105a and connectors 105b, 105c move down, the connectors 105b, 105c being guided on the vertical members 103d, 103e. The connectors 105b, 105c are fixed to the vertical members 105d, 105e of the frame portion 105. The vertical members 105d, 105e are connected at a top thereof by the handle bar 120.

A sack 121 is mounted to the first portion 103. The sack 121 is preferably a fabric sack with a re-closable top opening 121a, such as being reclosable by a zipper 130. The sack is similar to a backpack sack and may have a main compartment 122a closed by the zipper 130, and a smaller, front pocket 122b having a top opening 123, closed by a zipper 124. The sack 121 can hold bean bags or other items in the main compartment and a watch, car keys and the like in the smaller pocket 122b. The sack 121 includes a pair of strap assemblies that each includes straps 126a, 126b that terminate in mutually engageable, strap-fastening elements 127a, 127b. The sack is fastened to the crossbar 103a of the frame portion 103 by the straps 126a, 126b extending above and below the crossbar and being fastened on a front side of the crossbar by the strap-fastening elements 127a, 127b. Bottom straps 128a, 128b can be used to encircle the frame portion 103 and be connected by mutually engageable strap-fastening elements 129a, 129b.

A scoring meter 132 extends upward from the frame 102 or from the grip handle 120a. Scoring meter 132 includes a scoreboard 133 supported on a vertical spindle 135. The scoreboard 133 includes numbered notches or lines 134 indicating the game score. Colored tabs, clips, or pegs 136, 138 are manually movable along scoreboard 133 representing the current game score of each Team 1 and Team 2.

The meter 132 can be removable erected onto a bracket 139 that is connected to the handle bar 120 or to the grip handle 120a. The bracket 139 has an inverted, substantially U-shaped configuration with a notch 141 for receiving a bottom portion 145 of the spindle 135, the bottom portion 145 located between an upper flange 147 and a lower flange 148 on the spindle 135. The flanges 147, 148 are spaced to cause a resilient or friction fit on the bracket 139 above and below the notch 141 when resiliently slid into the notch. The scoreboard will thus be held vertical above the bracket 139. When not in use, the meter is removed and put into the bag 28 for storage.

Two drink container holders 151, 153 extend from the vertical members 105d, 105e of the inverted U-shaped second frame portion 105. The drink holders 151, 153 are advantageously composed of plastic and each include a resilient clamp base 154, a cantilever bracket 156 extending from the base 154, and a drink container receptacle 156.

The base 154 includes a semi-cylindrical base part 154a and two c-clasp parts 154c, 154d spaced apart along a height of the base part 154a and facing toward each other. The c-clasp parts 154c, 154d resiliently grip the respective vertical member 105d, 105e against the base part 154a. Each c-clasp part 154c, 154d includes an extending tab 154e that can be used to pry open the c-clasp parts 154c, 154d to release the holder from the vertical member, such as for storage, replacement or cleaning. The base 154 can be rotated and slid vertically on the vertical member to orient the receptacle 156 to a desired position or turned inward for storage. Each receptacle has a smaller diameter lower section to retain small diameter containers and a larger upper section for larger containers.

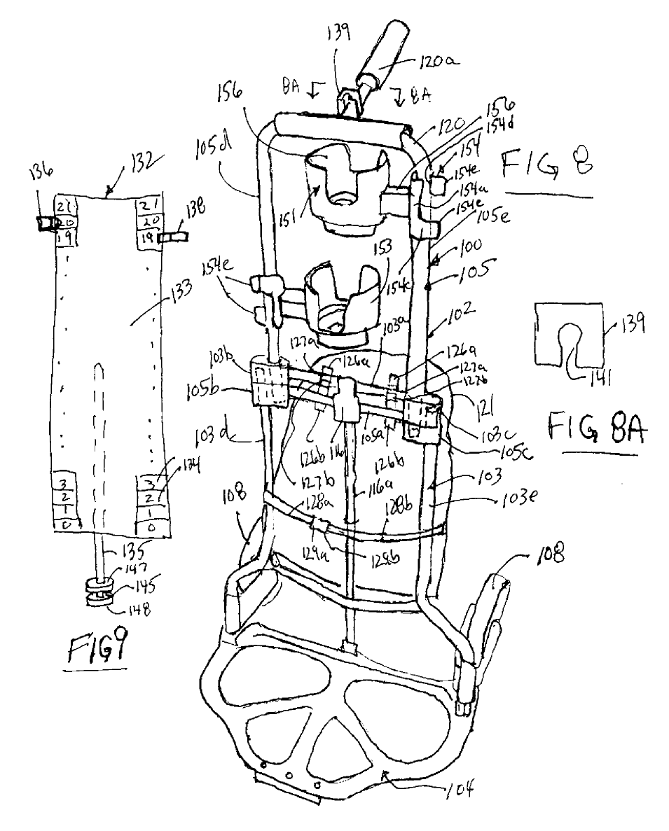

FIG. 7 shows the drink holders 151, 153 pivoted outward such as would be preferable to hold drinks during the bean bag game. FIG. 8 shows the drink holders 151, 153 slid to be offset vertically and then rotated inward to a position between the vertical members such as would require the least storage space for placement of the dolly in a car trunk or in a closet.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A dolly for transporting a beanbag goal, comprising:
a support frame;
wheels rotatably held by said support frame;
a lifting plate for supporting a goal, said lifting plate extending from said support frame; and
a drink holder supported by said frame.

2. The dolly according to claim 1, wherein said drink holder comprises a bracket extending from said support frame and a drink container receptacle supported by said bracket.

3. The dolly according to claim 1, wherein said drink holder comprises a utility shelf that includes formations for holding drink containers.

4. The dolly according to claim 3, wherein said utility shelf comprises fasteners to retain snack bags or other items.

5. The dolly according to claim 2, wherein said utility shelf is detachable and fastenable in both deployed and stored positions.

6. The dolly according to claim 2, wherein said utility shelf is attached to a sleeve which is slipped onto said support frame.

7. The dolly according to claim 1, wherein said drink holder is hingedly mounted to said support frame.

8. A dolly for transporting a beanbag goal comprising:
a support frame;
wheels rotatably held by said support frame;
a lifting plate extending from said support frame; and
a storage container carried by said support frame.

9. The dolly according to claim 8, wherein said storage enclosure is a bag.

10. The dolly according to claim 9, wherein said storage enclosure includes an access opening and a closing means for repeatedly closing and opening said access opening.

11. The dolly according to claim 10, wherein said closing means comprises a zipper.

12. The dolly according to claim 8, wherein said storage container is attached to said support frame.

13. The dolly according to claim 8, wherein said storage container is attached to a sleeve which is slipped onto said support frame.

14. A dolly for transporting a beanbag goal, comprising:
a support frame;
wheels rotatably held by said support frame;
a lifting plate extending from said frame; and
a scoring indicator carried by said support frame.

15. The dolly according to claim 14, wherein said scoring indicator includes a scoreboard with score indication marks for each of two teams.

16. The dolly according to claim 15, wherein said score indicator comprises clips movable along the score indication marks.
